(19) United States
(12) Patent Application Publication
(10) Pub. No.: US 2011/0318096 A1
(43) Pub. Date: Dec. 29, 2011

(54) Dual Material Device, Casing and Vehicle Provided With Said Device, and Method for Making Said Device

(75) Inventor: David Lausch, Ludres (FR)

(73) Assignee: Peugeot Citroen Automobiles SA, Velizy Villacoublay (FR)

(21) Appl. No.: 13/254,392

(22) PCT Filed: Feb. 15, 2010
(86) PCT No.: PCT/FR2010/050253

§ 371 Date: Sep. 1, 2011

(30) Foreign Application Priority Data
Mar. 4, 2009 (FR) 0951346

(51) Int. Cl. F16B 11/00; F02F 7/00; B21K 3/00; F16C 35/02

(52) U.S. Cl. 403/265; 384/429; 123/195 R; 29/888.01

(57) ABSTRACT

The invention relates to a dual material device that includes an insert (12), a part (14) made of a material other than that of) the insert, the insert and the part being assembled by moulding one around the other, the interface between the insert and the part defining at least one junction plane (40), and a bore (26, 28) for receiving a pin, formed in said device and extending through the junction plane, wherein the bore includes an inlet chamfer (36) for guiding the pin up to a pin engagement section (38), characterised in that the inlet chamfer (36) extends beyond the junction plane (40).

### CROSS-REFERENCE TO RELATED APPLICATIONS

The present application is the US National Stage under 35 U.S.C. §371 of PCT/FR2010/050253 which was filed on Feb. 15, 2010 and which claims the priority of French application 0951346 filed on Mar. 4, 2009.

### BACKGROUND

The invention relates to a two-material device comprising an insert and a part. The invention also relates to a housing and a vehicle equipped with this device and a fabrication method for this device.

Known two-material devices comprise an insert and a part made from a material different than the insert, whereby the insert and part are assembled by molding one around the other. And interface is formed between the part and the insert which defines at least one joint plane. A bore in which a pin is installed is made in this device so that the bore traverses the joint plane and has a lead-in chamfer to guide the pin up to a press fit section of this bore.

Typically, these known devices are found in housings of combustion engines of automotive vehicles. Indeed, an engine housing is divided in two parts called, respectively, “cylinder block” and “crank case”. For instance, the crank case comprises cast iron inserts forming the bearings of the crankshaft. Each insert is embedded in an aluminum part which forms the frame of the crank case. This assembly of the insert and the aluminum part is obtained by molding the aluminum around the insert.

However, cast iron has different metallurgical characteristics than the aluminum part. For instance, cast iron and aluminum do not have the same melting point.

Although the insert adheres solidly to the aluminum part, the cast iron and aluminum do not mix during the fabrication of the crank case. Therefore, there is an interface between the insert and the aluminum part which defines one or more joint planes between the materials of these elements.

Several bores are made in the crank case for receiving centering pins. With these pins, the cylinder block is positioned accurately on the crank case. These bores traverse the joint plane.

In this context, it has been observed that during the assembly of the engine, the machine assembling the centering pins in the bores frequently encountered problems. For instance, it happens that the pin is too large to be press fit in the bore, which causes the machine to fail. In addition, the pinning of crank case and cylinder block is sometimes bad, which can cause damage to the engine.

### BRIEF SUMMARY

The goal of the invention is to remedy these problems by proposing an improved device for facilitating the insertion of the pin in the bore.

To remedy the problem a two-material device is provided in which the entry chamfer of the bore extends beyond the joint plane.

It has been observed that at the level of the joint plane, given that the insert does not mix with the part during molding, a material shoulder is formed which protrudes into the bore. This shoulder jams the pin when the pin is introduced in the bore. This is what causes the failures of the assembly machine and the damage to some housings.

The lead-in chamfer of the bore allows for a light lateral displacement of the pin during its introduction in the bore. Due to this lateral displacement, the pin is guided and correctly positioned before it is locked in the press fit section of the bore. To this end, the lead-in chamfer of the bore has a diameter which is made accurately greater than the press fit section of the bore in which the pin is locked and therefore greater than the diameter of the pin.

In the above device, the lead-in chamfer of the bore extends beyond the joint plane. In the joint plane, the bore diameter is made accurately greater than the diameter of the pin to be introduced into the bore. In these conditions, even if there is a slight shoulder protruding into the bore at the level of the joint plane, it will not prevent the pin from passing through because there is sufficient lateral displacement. Consequently, the above device prevents the pin from jamming during its introduction into the bore. The failures of the assembly machine and the deteriorations of the engine equipped with this device are therefore reduced or eliminated.

The implementation modes of this device can comprise one or more of the following characteristics:
The largest transverse width of the press fit section of the bore in a plane parallel to the joint plane is made accurately smaller than the largest transverse width of the lead-in chamfer of the bore in the joint plane;
The difference between the largest transverse widths of the press fit section of the bore and the lead-in chamfer of the bore is at least greater than 0.05 mm and by preference greater than 0.5 mm;
The insert and part are made of different metals;
The insert is made of cast iron and the part of aluminum;
The device also comprises the pin locked in the bore, wherein the pin is made of material with a hardness lower than or equal to the hardness of the materials used to make the insert and part;
The insert forms a bearing support for the crankshaft of a combustion engine and the part forms a part of the housing of this combustion engine.

Also disclosed is a housing of a combustion engine of a vehicle equipped with the above device.

Additionally, a vehicle comprising this housing is disclosed.

Finally, a method is disclosed for fabricating this two-material device. The method comprises the machining of the lead-in chamfer of the bore so that this lead-in chamfer extends beyond the joint plane.

### BRIEF DESCRIPTION OF THE SEVERAL VIEWS OF THE DRAWINGS

The device will be better understood by reading the following description, provided strictly as a non-limiting illustrative example, and with reference to the drawings in which:

FIG. 1 is a schematic illustration in cross-section of a vehicle equipped with a combustion engine housing,

FIG. 2 is a schematic illustration in cross-section of a bore made in the housing of FIG. 1 for receiving the centering pin, the cross-section being taken along circle E of FIG. 1,

FIG. 3 is an enlargement of a detail of FIG. 2, taken along circle F of FIG. 2,

FIG. 4 is a schematic illustration in perspective of a crank case of the housing of FIG. 1, and

FIG. 5 is a flowchart of the fabrication and assembly method for the housing of FIG. 1.

FIG. 1 shows a vehicle 2 equipped with a housing 4 of an internal combustion engine. The vehicle 2 is schematically represented by a rectangle in phantom line. This vehicle 2 is for instance an automotive vehicle such as a passenger car.

The housing 4 comprises an upper part 6 called “cylinder block” and a lower part 8 called “crank case”. The upper and lower parts are joined together at the level of assembly plane 10, which is horizontal in FIG. 1.

The cylinder block 6 is conventional and will not be described in more detail here.

The crank case 8 comprises an insert 12 embedded without any degree of freedom in a shell 14. The insert 12 forms a bearing support for the crankshaft of the internal combustion engine, which will be installed in housing 4. For instance, the upper part of the insert 12 defines a face 16 in the shape of a half circle. This face 16 is intended to support the rotating crankshaft. To limit the wear of this surface 16, the insert 12 is made of a very hard material such as cast iron.

Here, the insert 12 is vertically traversed by two mounting holes 18 and 20. When the crank case and cylinder block are assembled together, these two holes 18 and 20 extend beyond assembly plane 10 inside the cylinder block 6. The extremities of these holes 18 and 20 are situated inside the cylinder block 6 and are threaded. In fact, the bolts used for mounting crank case and cylinder block together are installed in these holes 18 and 20.

The shell 14 is made of a material that is softer than the material used to make the insert 12. For instance, the shell 14 is made of aluminum. To install the insert 12 in the shell 14, the insert is inserted during the molding of the shell 14. Given that the material of the shell 14 has different metallurgical characteristics than the material used to make the insert 12, the materials of the shell 14 and insert 12 will not mix. For instance, the materials of the insert 12 and shell 14 have different melting points.

Once cooled, there is an interface 24 between the two materials.

Two bores 26 and 28 are also shown on FIG. 1. These bores 26 and 28 cut first vertically through the shell 14 and then through the insert 12 to end in the cylinder block 6. These bores 26, 28 extend along respective vertical axes 30, 32.

For instance, bores 26 and 28 are identical and only the bore 26 will be described here in detail.

The bore 26 extends upwardly. The opening 34 of the bore 26, through which the centering pin is introduced, is located on the bottom of the insert 12. Then, starting from this opening 34 and going up, the bore 26 has a lead-in chamfer 36 which extends into a press fit section 38. Chamfer 36 is designed to guide the introduced pin and to align the axis of this pin with axis 30 of the bore, before the pin is introduced into section 38. To this end, the inner diameter of chamfer 36 gradually decreases from the diameter of opening 34 to the diameter of the press fit section 38 when moving upward. For instance, the diameter of chamfer 36 decreases in stages.

Section 38 of the bore is intended to retain with a press fit the pin introduced in the bore 26. For this purpose, the diameter of section 38 is selected for a press fit of the pin. For instance, the diameter of section 38 is equal to the diameter of the pin to be introduced into the bore.

Here, the bore 26 traverses the interface 24 between the shell 14 and the insert 12 at the level of the joint plane 40.

Here, the plane 40 is perpendicular to the axis 30.

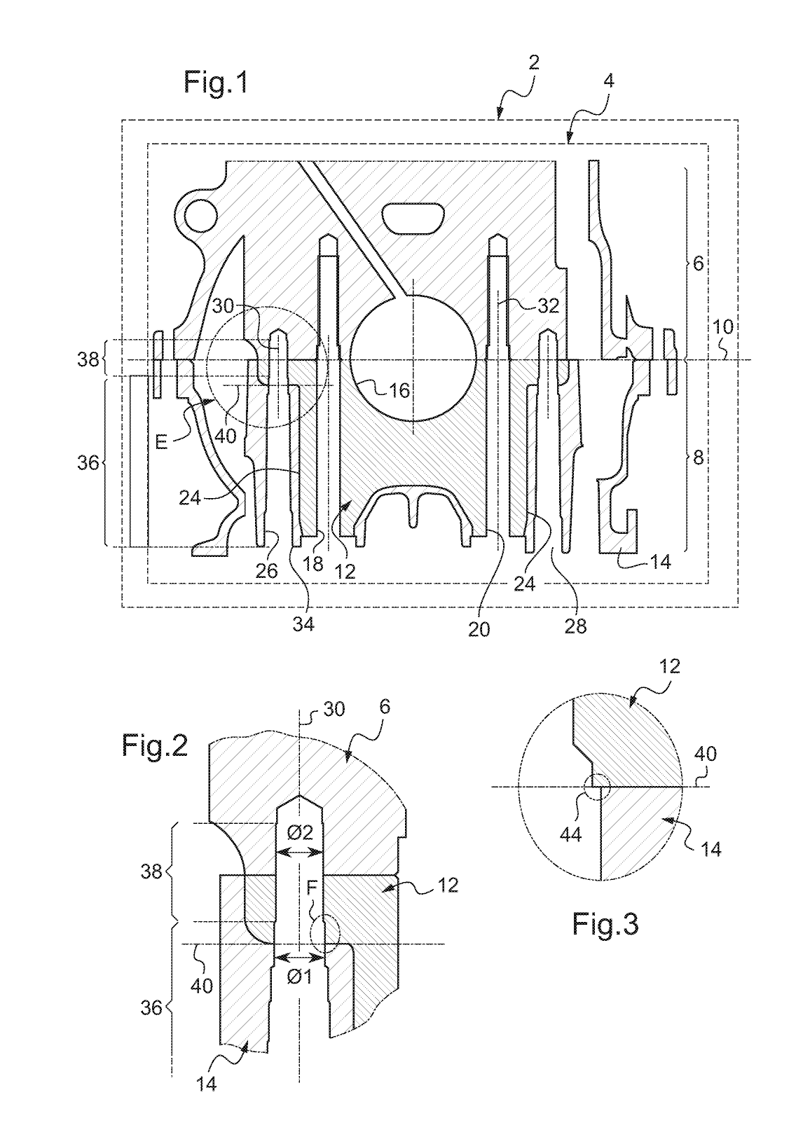

An area E surrounding plane 40 is shown in more detail in FIG. 2.

The chamfer 36 extends upwardly, beyond the plane 40. In the plane 40, the chamfer 36 has an inner diameter φ₁ which is made accurately greater than the inner diameter φ₂ of section 38. For instance, the diameter φ₂ is equal to the diameter of the pin intended to be introduced in bore 26.

An area F surrounding the intersection of chamfer 36 with insert 12 at the level of plane 40 is shown in enlarged form on FIG. 3.

Due to the different materials used for the shell 14 and insert 12, at least one of these materials forms a shoulder 44 (FIG. 3) protruding inside bore 26. For instance, here, the insert 12 forms the shoulder 44.

This shoulder 44 protrudes a few hundredths or tenths of a millimeter inside the bore 26. However, here, the difference between diameters φ₁ and φ₂ is selected to be sufficiently large so that shoulder 44 will not provoke galling of the pin during its introduction in bore 26. The difference between diameters φ₁ and φ₂ is selected to be greater than 0.05 mm and by preference greater than 0.5 mm. In this way, even if shoulder 44 is formed, the shoulder will be retracted relative to section 38 and will therefore not hinder in any way the introduction of the pin in this section.

Here, the hardness of the material of the insert 12 is greater than or equal to the hardness of the material used to make the pin to be introduced into the bore.

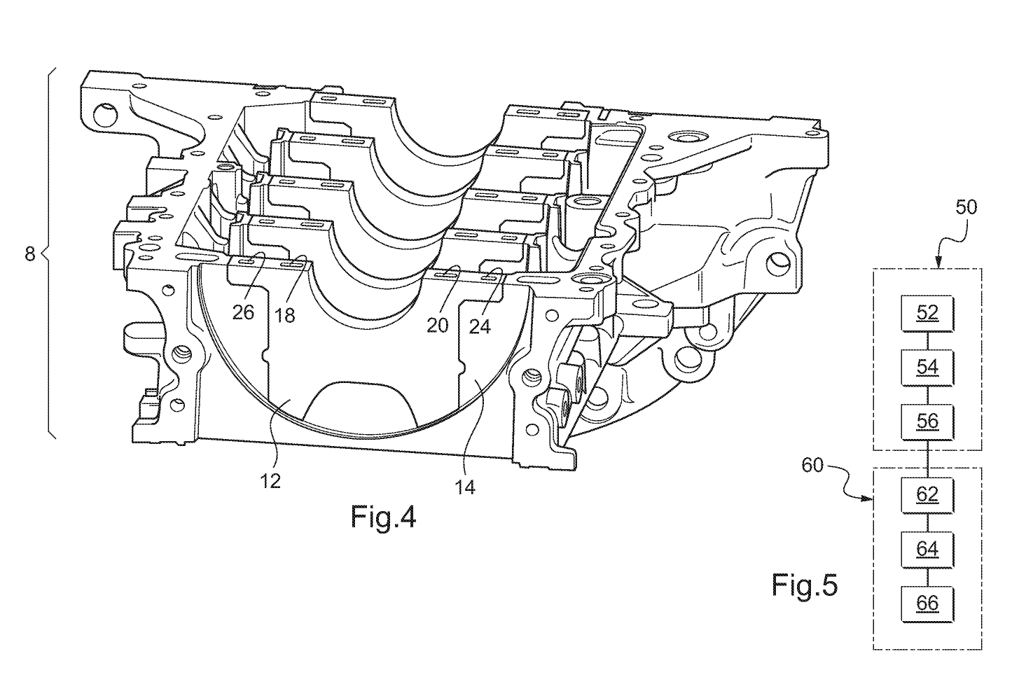

FIG. 4 shows the crank case 8 in perspective. This perspective view shows that the crank case 8 comprises several inserts identical to insert 12.

The fabrication and assembly of the housing 4 will now be described in more detail with respect to the method of FIG. 5.

Initially, the assembly begins with a manufacturing phase 50 in which crank case 8 is fabricated. This phase 50 comprises a step 52 in which aluminum is poured around the insert 12 in a mold for forming the shell 14 on which this insert 12 is solidly mounted. During this molding step, it is accepted that a film of air is present between the insert 12 and shell 14, which prevents a perfect joint of the insert 12 to the shell 14.

Then, during a step 54, the cylinder block is assembled on top of the crank case 8 and the cylinder block and crank case are joined together through the intermediary of assembly plane 10.

In this position, during step 56, holes 18, 20 and bores 24 and 26 are machined.

In particular, during step 56, the lead-in chamfer 36 and section 38 of the bores are machined in such a manner that the lead-in chamfer of the bores extends beyond the plane 40.

Then, once all the machining is complete, the method continues with phase 60 in which the engine is assembled.

During step 62, after having installed the crankshaft, the cylinder block 6 is centered on the crank case 8 by means of, for instance, centering dowels. Then, during step 64, the centering pins are introduced into bores 26 and 28 until their extremities are fitted inside the sections 38. From then on, these centering pins are retained with a press fit inside the bores 26 and 28.

Finally, during step 66, bolts are introduced in holes 18 and 20 to complete the assembly of cylinder block and crank case.

Numerous other embodiments are possible. For instance, the transverse section of the bores and centering pins is not necessarily circular. For instance, they can be cylindrical but with a different generating circle.

What has been described here in the particular case of a two-material crank case applies equally to any other two-material device. It is also not necessary that the materials constituting this device are cast iron and aluminum. For instance, two other metals can be applied with different metallurgical characteristics. What has been described applies equally to two-material devices in which at least one or both materials are not metals.

1. A two-material device comprising an insert and a part made of a material different than the material from which the insert is made, whereby the insert and part are assembled by molding one around the other; the insert and the part defining an interface therebetween, the interface defining at least one joint plane; the device further including a bore for receiving a pin, The bore traversing the joint plane, the bore having a lead-in chamfer and a press fit section; the lead-in chamfer being adapted to guide the pin up to the press fit section the lead-in chamfer extending beyond the joint plane.

2. The device according to claim 1, wherein the lead-in chamfer and the press fit section of the at least one bore each have a transverse width; wherein a largest transverse width of the press fit section in a plane parallel to the joint plane is accurately smaller than a largest transverse width of the lead-in chamfer in the joint plane.

3. The device according to claim 2, in which the difference between the largest transverse widths of the press fit section and of the lead-in chamfer is at least greater than 0.05 mm.

4. The device according to claim 1, in which the insert and the part are made of different metals.

5. The device according to claim 4, in which the insert is made of cast iron and the part of aluminum.

6. The device according to claim 1, in which the device also comprises the pin press fit in the bore, the pin being made of a material with hardness less than or equal to the hardness of at least one of the materials used to make the insert and the part.

7. The device according to claim 1, in which the insert forms a bearing support for a crankshaft of a combustion engine and the part forms a part of a housing of the combustion engine.

8. A housing for a combustion engine of a vehicle, wherein the housing comprises the device of claim 1.

9. A vehicle comprising the housing according to claim 8.

10. A method for fabricating the device according to claim 1, the method comprising a step of machining the lead-in chamfer in such manner that the lead-in chamfer extends beyond the joint plane.

11. The device according to claim 2 in which the difference between the largest transverse widths of the press fit section and of the lead-in chamfer is at least greater than 0.5 mm.
